(19) United States
(12) Patent Application Publication
(10) Pub. No.: US 2005/0005297 A1
(43) Pub. Date: Jan. 6, 2005

(54) Wireless set-top box system and method for multi-device monitoring

(75) Inventor: Doo-hee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/767,336

(22) Filed: Jan. 30, 2004

(30) Foreign Application Priority Data
Jul. 1, 2003 (JP) 2003-44251

(51) Int. Cl. H04N 7/18; G06F 13/00; H04N 5/445; G06F 3/00; H04N 7/00; H04N 11/00

(52) U.S. Cl. 725/81; 348/552; 725/37; 725/38; 725/80

(57) ABSTRACT

A wireless set-top box system for monitoring includes a set-top box which externally receives function control instructions, generates on-screen-display (OSD) information corresponding to the function control instruction, displays the OSD information on a respective screen, and wirelessly transmits the function control instruction; and a display device which receives the function control instructions wirelessly transmitted by the set-top box, generates OSD information corresponding to the function control instruction, and displays the OSD information on a different screen corresponding to the display device.

This application claims the priority of Korean Patent Application No. 2003-44251, filed on Jul. 1, 2003, in the Korean Intellectual Property Office, the disclosure of which is incorporated herein in its entirety by reference.

### BACKGROUND OF THE INVENTION

1. Field of the Invention

The present invention relates to a wireless set-top box system, and more particularly to a wireless set-top box system and method for multi-device monitoring in both a set-top box and a display device.

2. Description of the Related Art

Generally, a set-top box system includes a set-top box and a television set connected to the set-top box by a wire or a wireless connection. The set-top box converts digital video signals received via an antenna into analog video signals. The television set displays video signals output by the set-top box on a screen. The television set may be located far from the set-top box and a user far from the set-top box can watch the television set. For example, the set-top box may be installed in a living room while the television set is installed in a bedroom. The set-top box is equipped with a remote control, which can be used by a user to control various functions of the set-top box remotely. When the user transmits control instructions with the remote control, a display window of the set-top box or a monitor connected to the set-top box by a cable displays corresponding on-screen-display (OSD) information. However, such OSD information is not displayed on the television set.

For example, if the user of the set-top box transmits an instruction of “volume down” using the remote control, the instruction is displayed in the display window of the set-top box or the monitor connected to the set-top box by cable, but not on the television set. In other words, if the user sends an instruction to the set-top box without a notice, a person watching another television remotely connected to the set-top box will not see what has changed in the set-top box.

### SUMMARY OF THE INVENTION

The present invention provides a wireless set-top box system and method for multi-device monitoring in both a set-top box and a display device.

According to an aspect of the present invention, there is provided a wireless set-top box system for multi-device monitoring comprising, a set-top box which externally receives function control instructions, generates on-screen-display (OSD) information corresponding to the function control instruction, displays the OSD information on a screen, and wirelessly transmits the function control instruction; and

a display device which receives the function control instructions wirelessly transmitted by the set-top box, generates OSD information corresponding to the function control instruction, and displays the OSD information on a screen.

It is preferable that the set-top box comprises a first signal processor which extracts transport streams from broadcast signals, decodes the transport streams into video/audio signals, and manipulates the video/audio signals according to the function control instructions; an infrared receiving unit which receives infrared key signals from a remote control and amplifies the infrared key signals to a predetermined amplitude; a first controller which extracts a key code that corresponds to the function control instruction from the infrared key signals received from the infrared receiving unit, and outputs the key code corresponding to the function control instruction to the first signal processor; a first OSD generating unit which generates OSD information corresponding to the key code generated by the first controller; a first mixing unit which mixes video signals generated by the first signal processor and the OSD information generated by the OSD generating unit; a first display unit which displays the mixed signals of the video signals and the OSD information received from the first mixing unit; and a transmitting module which converts the transport streams extracted by the signal processor and the key code extracted by the first controller into radio signals in a predetermined format and transmits the radio signals through different channels.

It is preferable that the display device comprises, a receiving module which divides the radio signals received from the transmitting module into the transport streams and the key code; a second signal processor which decodes the transport streams received from the receiving module to video/audio signals and manipulates the video/audio signals according to a function control instruction; a second controller which extracts the key code that corresponds to the function control instruction from the radio signals received from the receiving module, and outputs the key code corresponding to the function control instruction to the second signal processor; a second OSD generating unit which generates OSD information corresponding to the key code generated by the second controller; a second mixing unit which mixes video signals generated by the second signal processor and the OSD information generated by the second OSD generating unit; and a second display unit which displays the mixed signals of the video signals and the OSD information generated by the second mixing unit.

According to another aspect of the present invention, there is provided a multi-device monitoring method in a set-top box system comprising a set-top box and a display device wirelessly connected to each other, the method comprising, (a) the set-top box in response to a received key instruction, generating and displaying OSD information that corresponds to the key instruction on a screen while wirelessly transmitting the key instruction; (b) the display device generating OSD information that corresponds to the key instruction received from the set-top box and displaying the OSD information on a screen.

It is preferable that step (a) comprises, converting the received key instruction to a corresponding key code which is stored in advance; generating OSD information that corresponds to a function control instruction of the key code while modulating the key code to a radio signal; and transmitting the modulated radio signal through a channel separate from an audio/video channel.

It is preferable that step (b) comprises, receiving the radio signal through the channel separate from the audio/video channel; demodulating the radio signal to extract the key code; and generating OSD information that corresponds to the key code and displaying the OSD information on the screen of the display device.

### BRIEF DESCRIPTION OF THE DRAWINGS

The above and other aspects and advantages of the present invention will become more apparent by describing in detail a preferred embodiment thereof with reference to the attached drawings in which:

FIG. 1 is a schematic block diagram of a wireless set-top box system for multi-device monitoring according to a preferred embodiment of the present invention;

FIG. 2 is a detailed block diagram of the wireless set-top box of FIG. 1;

FIG. 3 is a detailed block diagram of a display device of FIG. 1;

FIG. 4 is a flowchart illustrating the operation of a set-top box in the set-top box system for multi-device monitoring according to the present invention; and

FIG. 5 is a flowchart of the operation of a display device in the wireless set-top box system for multi-device monitoring according to a preferred embodiment of the present invention.

### DETAILED DESCRIPTION OF THE INVENTION

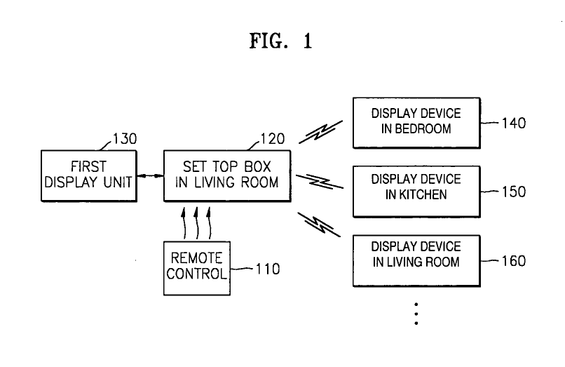

FIG. 1 is a schematic block diagram of a wireless set-top box system according to a preferred embodiment of the present invention.

The set-top box system includes a set-top box 120 and a plurality of display devices 140, 150, 160 . . . .

A remote control 110 transmits various control instructions to the set-top box 120 to control various operational functions of the set-top box 120.

The set-top box 120 can communicate with the display devices 140, 150, 160 . . . . For example, it may be assumed that the set-top box 120 is installed in a living room, and the display devices 140, 150, 160 are installed in a bedroom, a kitchen, and the living room, respectively, each of which is located far from the set-top box 120. Each of the set-top box 120 and the display devices 140, 150, 160 . . . includes a radio transceiver module to transmit/receive various kinds of signals via a wireless local area network (LAN) in a 5 GHz band and/or a 430 MHz band.

The set-top box 120 converts digital broadcast signals into analog broadcast signals, displays key signals received from the remote control 110 on a first display unit 130 connected to the set-top box 120 by cable in an on-screen-display (OSD) format, and wirelessly transmits the broadcast signals and the key signals.

Each of the display devices 140, 150, 160, . . . displays the broadcast signals and key signals received from the set-top box 120 on the screen in an OSD format.

Accordingly, OSD information which corresponds to the key instruction is displayed on the first display unit 130 of the set-top box 120 as well as on the display devices 140, 150, 160 . . . . For example, if a user transmits an instruction of “volume down” to the set-top box 120 using the remote control 110, OSD information of the “volume down” is not only displayed on the first display unit 130 of the set-top box 120 but also on the display devices 140, 150, 160 . . . . Therefore, viewers who are watching display devices 140, 150, 160, . . . can recognize what function is controlled by the set-top box 120.

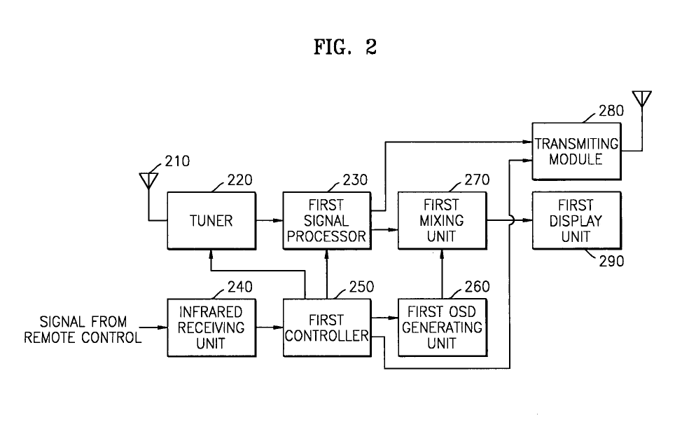

FIG. 2 is a detailed block diagram of the set-top box of FIG. 1.

Referring to FIG. 2, a tuner 220 tunes to broadcast signals received via an antenna 210 according to tuning control data generated by a first controller 250.

A first signal processor 230 extracts transport streams from the broadcast signals output by the tuner 220, and decodes the transport streams into Red, Green, Blue (RGB) video signals and/or audio signals to be output to a cathode ray tube (CRT) and/or a speaker. The first signal processor 230 also manipulates the video and/or audio signals according to function control instructions generated by the first controller 250. For example, when receiving an instruction of “volume down” from the first controller 250, the signal processor 230 lowers the volume level of the audio signals.

An infrared receiving unit 240 amplifies infrared signals transmitted by the remote control 110 (FIG. 1) to a predetermined amplitude.

The first controller 250 extracts key codes, which correspond to function control instructions, from the infrared signals received from the infrared receiving unit 240, and outputs the key codes to the signal processor 230 or to another operational processor (not shown), and provides the tuning control data for the tuner 220.

A first OSD generating unit 260 generates OSD information corresponding to the key code output by the controller 250.

A first mixing unit 270 mixes the video signals output by the signal processor 230 and the OSD information output by the OSD generating unit 260.

A first display unit 290 displays the mixed signals of the video signals and the OSD information output by the mixing unit 270 via a CRT (not shown).

A transmitting module 280 modulates the transport streams and the key codes to a predetermined format of radio signals and transmits them through different respective channels. For example, the transport streams are modulated to orthogonal frequency divisional multiplexed (OFDM) signals and transmitted in a 5 GHz band, and the key code is modulated to radio frequency (RF) signals and transmitted in a 430 MHz band.

FIG. 3 is a detailed block diagram of a display device of FIG. 1.

Referring to FIG. 3, a receiving module 320 divides the radio frequency signals transmitted through 5 GHz and 430 MHz bands into transport streams and key codes and demodulates the transport streams and the key codes.

A second signal processor 330 decodes the transport streams demodulated by the receiving module 320 into RGB video signals and/or audio signals, and manipulates the video and/or audio signals based on function control instructions received from a second controller 350. For example, when receiving an instruction of “volume down” from the second controller 350, the second signal processor 330 lowers the level of the audio signals.

The second controller 350 extracts key codes, which correspond to function control instructions, from the radio frequency signals received from the receiving module 320 and outputs the key codes to the signal processor 330 or another operational processor (now shown).

A second OSD generating unit 360 generates OSD information which corresponds to the key codes, received from the second controller 350.

A second mixing unit 340 mixes video signals generated by the second signal processor 330 and the OSD information generated by the second OSD generating unit 360.

A second display unit 370 displays the mixed signals of the video signals and the OSD information via a CRT (not shown).

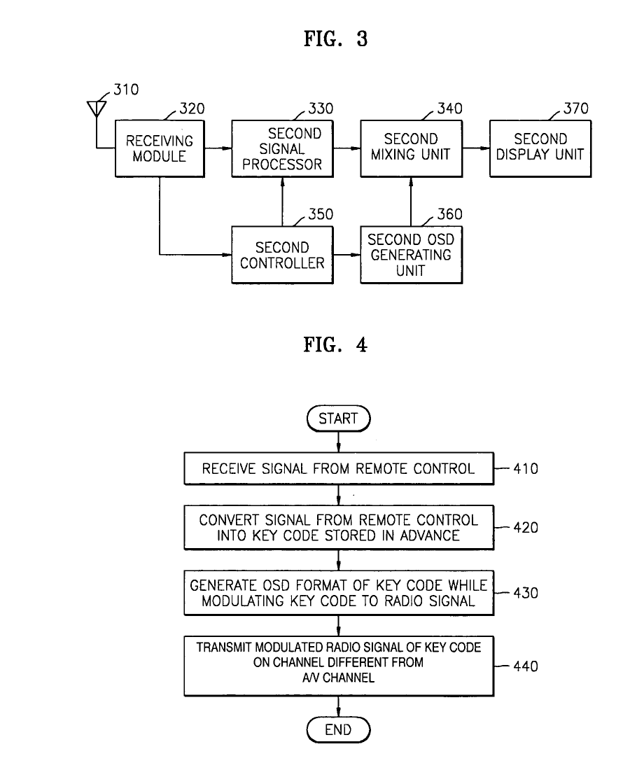

FIG. 4 is a flowchart illustrating the operation of a set-top box in the wireless set-top box system for multi-device monitoring according to a preferred embodiment of the present invention. It is assumed that a user may control functions of the set-top box by sending infrared signals using a remote control, and that common function control instructions corresponding to key codes are defined between the set-top box and display devices connected to the set-top box.

First, infrared key signals are received from the remote control in step 410.

In step 420, the infrared key signals received from the remote control are converted to corresponding key codes which are stored in advance. Each key code corresponding to a key signal received from the remote control should be stored in a memory device in advance.

Each received key code is converted to OSD information which corresponds to a function control instruction while the key code is modulated to a radio signal using a predetermined format in step 430.

The radio signal of the key code is transmitted through a separate channel than an audio/video channel in step 440.

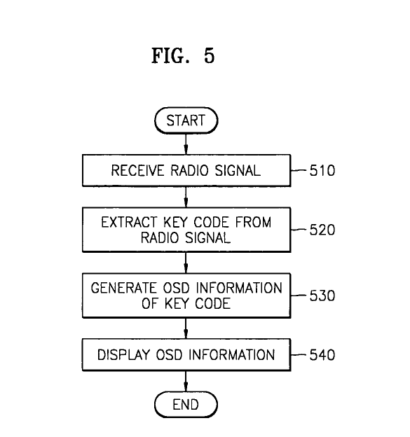

FIG. 5 is a flowchart illustrating the operation of a display device in the wireless set-top box system for multi-device monitoring according to a preferred embodiment of the present invention.

A radio signal including a key code in a predetermined format is received through a channel separate from an audio/video channel in step 510.

The radio signal is demodulated to extract the key code in step 520.

The key code is converted to OSD information in step 530.

The OSD information is displayed on a screen of the display device in step 540. The OSD information displayed on the screen of the display device is the same OSD information as displayed on a screen of a set-top box.

As described above, multi-device monitoring is achieved between a set-top box and television sets by sharing the same OSD instructions, to provide convenience for users watching the television sets connected to the set-top box.

While this invention has been particularly shown and described with reference to preferred embodiments thereof, it will be understood by those skilled in the art that various changes in form and details may be made therein without departing from the spirit and scope of the invention as defined by the appended claims.

1. A wireless set-top box system comprising:
a set-top box operable to receive function control instructions, generate on-screen-display (OSD) information corresponding to the function control instruction, display the OSD information on a first screen, and wirelessly transmit the function control instruction; and
a display device operable to receive the function control instruction wirelessly transmitted by the set-top box, generate OSD information corresponding to the function control instruction, and display the OSD information on a second screen.

2. The system of claim 1, wherein the set-top box comprises:
a first signal processor operable to extract transport streams from broadcast signals, decode the transport streams into video and audio signals, and manipulate the video and audio signals according to the function control instructions;
an infrared receiving unit operable to receive infrared key signals from a remote control device and amplify the infrared key signals to a predetermined amplitude;
a first controller operable to extract a key code that corresponds to the function control instruction from the infrared key signals received from the infrared receiving unit, and output the key code corresponding to the function control instruction to the first signal processor;
a first OSD generating unit operable to generate OSD information corresponding to the key code generated by the first controller;
a first mixing unit operable to mix video signals generated by the first signal processor and the OSD information generated by the OSD generating unit;
a first display unit operable to display the mixed signals of the video signals and the OSD information received from the first mixing unit; and
a transmitting module operable to convert the transport streams extracted by the signal processor and the key code extracted by the first controller into radio signals in a predetermined format and transmit the radio signals through different respective channels.

3. The system of claim 2, wherein the display device comprises:
a receiving module operable to divide the radio signals received from the transmitting module into the transport streams and the key code;
a second signal processor operable to decode the transport streams received from the receiving module to video and audio signals and manipulate the video and audio signals according to a function control instruction;
a second controller operable to extract the key code that corresponds to the function control instruction from the radio signals received from the receiving module, and output the key code corresponding to the function control instruction to the second signal processor;
a second OSD generating unit operable to generate OSD information corresponding to the key code generated by the second controller;
a second mixing unit operable to mix video signals generated by the second signal processor and the OSD information generated by the second OSD generating unit; and
a second display unit operable to display the mixed signals of the video signals and the OSD information generated by the second mixing unit.

4. A monitoring method for a set-top box system comprising a set-top box and a display device wirelessly connected to each other, the method comprising:
(a) the set-top box, in response to a received key instruction, generating and displaying OSD information that corresponds to the key instruction on a set-top box screen and wirelessly transmitting the key instruction;
(b) the display device generating OSD information that corresponds to the key instruction received from the set-top box and displaying the OSD information on a display device screen.

5. The method of claim 4, wherein step (a) comprises:
converting the received key instruction to a corresponding key code which is stored in advance;
generating OSD information that corresponds to a function control instruction of the key code while modulating the key code to a radio signal; and
transmitting the modulated radio signal through a channel separate from an audio/video channel.

6. The method of claim 5, wherein step (b) comprises;
receiving the radio signal through the channel separate from the audio/video channel;
demodulating the radio signal to extract the key code;
generating OSD information that corresponds to the key code; and
displaying the OSD information on the display device screen.
